(19) United States
(12) Patent Application Publication
(10) Pub. No.: US 2024/0244177 A1
(43) Pub. Date: Jul. 18, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: KAZUHIKO NISHIBORI, TOKYO (JP); RYOHEI FUNAKOSHI, TOKYO (JP)

(21) Appl. No.: 18/560,286

(22) PCT Filed: Feb. 7, 2022
(86) PCT No.: PCT/JP2022/004615

§ 371 Date: Nov. 10, 2023

(30) Foreign Application Priority Data
Jun. 1, 2021 (JP) 2021-092099

(51) Int. Cl. H04N 13/351; H04N 13/117; H04N 13/161; H04N 13/305; H04N 13/398

(52) U.S. Cl. CPC H04N 13/351; H04N 13/117; H04N 13/161; H04N 13/305; H04N 13/398

(57) ABSTRACT

An information processing apparatus (10) includes a test pattern generation unit (17). The test pattern generation unit (17) generates a test pattern in which appearance of an image element indicating a positional relationship between a viewer and a viewing area continuously changes depending on a viewing position.

### FIELD

The present invention relates to an information processing apparatus, an information processing method, and a program.

### BACKGROUND

Known is a tracker type naked-eye stereoscopic display system that dynamically controls a viewing area by tracking positions of the viewer's eyes. The viewing area means a spatial region in which a 3D video can be stereoscopically viewed.

### CITATION LIST

### Patent Literature

Patent Literature 1: JP 5117613 B2

### SUMMARY

### Technical Problem

The positions of the viewer's eyes are calculated by applying measurement information of the viewer's face to a standard face model. Therefore, a calculation result includes an error according to an individual difference of a viewer. Patent Literature 1 proposes a technique in which a viewer adjusts a viewing area while observing a test pattern. The test pattern uses an image such as a circle or a double circle indicating whether the viewer is at the center of the viewing area. However, since the test pattern changes only discontinuously according to the viewing position, it is difficult to recognize at which position in the viewing area the viewer is located.

Therefore, the present disclosure proposes an information processing apparatus, an information processing method, and a program capable of recognizing in detail at which position in a viewing area a viewer is located.

### Solution to Problem

According to the present disclosure, an information processing apparatus is provided that comprises a test pattern generation unit configured to generate a test pattern in which appearance of an image element continuously changes depending on a viewing position, the image element indicating a positional relationship between a viewer and a viewing area. According to the present disclosure, an information processing method in which an information process of the information processing apparatus is executed by a computer, and a program for causing the computer to execute the information process of the information processing apparatus, are provided.

### BRIEF DESCRIPTION OF DRAWINGS

FIG. 1 is a diagram illustrating a schematic configuration of a display system.

FIG. 2 is a diagram illustrating an example of a functional configuration of the display system.

FIG. 3 is a diagram illustrating a flow of information processing in the display system.

FIG. 4 is a diagram illustrating an example of a method of detecting a viewer.

FIG. 5 is a diagram illustrating an example of a test pattern.

FIG. 6 is a diagram illustrating an example of a plane image group forming the test pattern.

FIG. 7 is a diagram illustrating an example in which a viewing position is located at the center of a viewing area.

FIG. 8 is a diagram illustrating an actual observation pattern.

FIG. 9 is a diagram illustrating an example in which the viewing position deviates from the center of the viewing area to the right side.

FIG. 10 is a diagram illustrating an actual observation pattern.

FIG. 11 is a diagram illustrating an example in which the viewing position deviates from the center of the viewing area to the left side.

FIG. 12 is a diagram illustrating an actual observation pattern.

FIG. 13 is a diagram illustrating an example in which the viewing position deviates from the center of the viewing area to the front side.

FIG. 14 is a diagram illustrating an actual observation pattern.

FIG. 15 is a diagram illustrating an example in which the viewing position deviates from the center of the viewing area to the back side.

FIG. 16 is a diagram illustrating an actual observation pattern.

FIG. 17 is a diagram illustrating an example of a method of adjusting a viewing area.

FIG. 18 is a diagram illustrating an example of user input processing.

### DESCRIPTION OF EMBODIMENTS

Hereinafter, embodiments of the present disclosure will be described in detail with reference to the drawings. In the following embodiments, the same parts will be denoted by the same reference numerals, and redundant description will be omitted.

It is noted that a description will be given in the following order.
[1. Outline of display system]
[2. Functional configuration of display system]
[2-1. Acquisition of sensor information]
[2-2. Viewer Detection]
[2-3. Calculation of viewing position]
[2-4. Generation of viewpoint image]
[2-5. Calculation of viewpoint index]
[2-6. Multiplexing of viewpoint images]
[3. Test pattern]
[4. Relationship between viewing position and observation pattern]
[4-1. Example in which viewing position is located at center of viewing area]
[4-2. Example in which viewing position deviates from center of viewing area to right side]
[4-3. Example in which viewing position deviates from center of viewing area to left side]
[4-4. Example in which viewing position deviates from center of viewing area to front side]
[4-5. Example in which viewing position deviates from center of viewing area to back side]
[5. Adjustment of viewing area]
[6. Effects]
[7. First modification]
[8. Second modification]
[9. Third modification]
[10. Fourth modification]

### 1. Outline of Display System

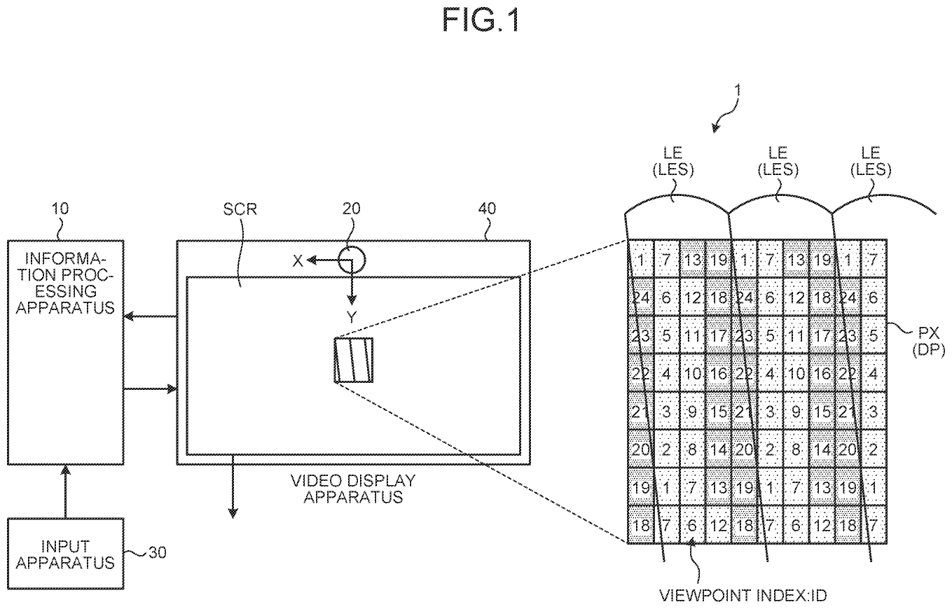

FIG. 1 is a diagram illustrating a schematic configuration of a display system 1.

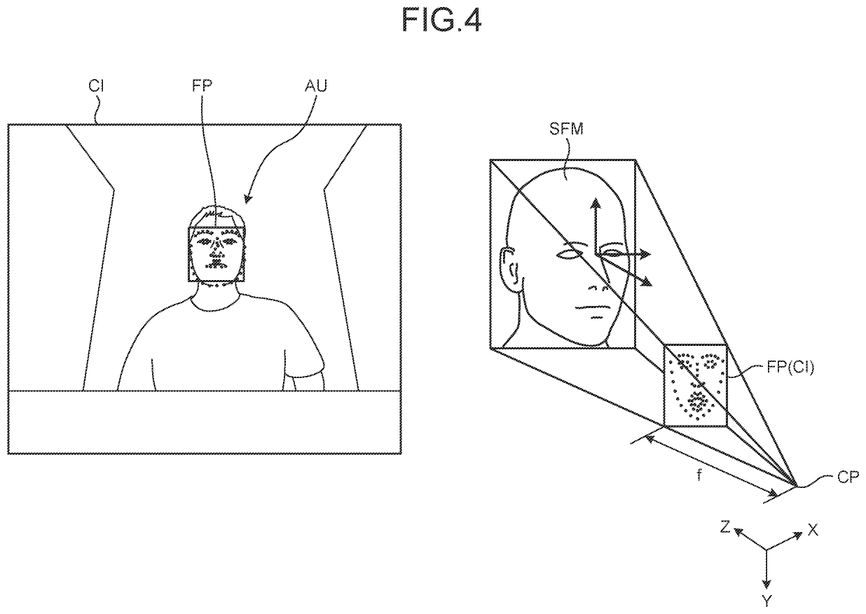

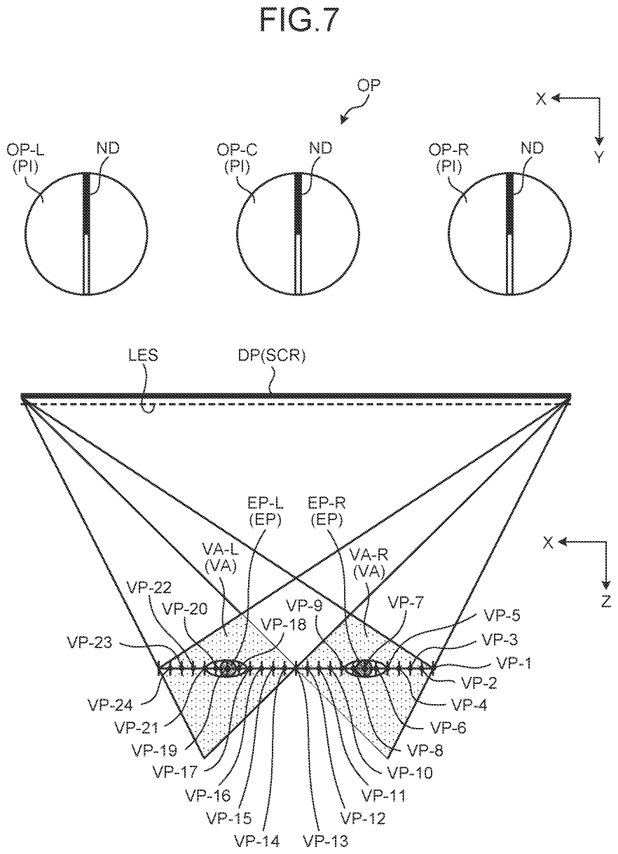

The display system 1 is a naked-eye stereoscopic display system that displays a 3D video in accordance with a viewing position. As illustrated in FIG. 7, a viewing position EP means, for example, the positions of a left eye EP-L and a right eye EP-R of a viewer AU (refer to FIG. 4). The display system 1 includes, for example, an information processing apparatus 10, a sensor unit 20, an input apparatus 30, a video display apparatus 40, and a storage apparatus 50.

The sensor unit 20 includes one or more sensors for sensing the outside world. The sensor unit 20 includes, for example, a visible light camera, a distance measurement sensor, a line-of-sight detection sensor, and the like. The visible light camera captures a visible light image of the outside world. The distance measurement sensor detects a distance of a real object existing in the outside world using a flight time of laser light or the like. The line-of-sight detection sensor detects a line of sight of the viewer AU directed to the video display apparatus 40 using a known eye tracking technique.

The input apparatus 30 includes a plurality of input devices capable of inputting various types of information by an input operation of the viewer AU. Examples of the plurality of input devices include a touch panel, a keyboard, a mouse, a microphone, and a remote controller.

The video display apparatus 40 presents various types of information such as video information and audio information to the viewer AU. The video display apparatus 40 includes a display panel DP and an image separation unit LES. The display panel DP displays a multiplexed image obtained by multiplexing a plurality of viewpoint images corresponding to the right eye EP-R and the left eye EP-L of the viewer AU. The image separation unit LES spatially separates the plurality of viewpoint images displayed on the display panel DP, and supplies the viewpoint images to the right eye EP-R and the left eye EP-L of the viewer AU. The video display apparatus 40 presents the 3D video to the viewer AU by guiding a plurality of spatially separated viewpoint images to the right eye EP-R and the left eye EP-L of the viewer AU.

As the display panel DP, a known 2D display such as a liquid crystal display (LCD) or an organic light-emitting diode (OLED) is used.

A plurality of known image separation means such as a parallax barrier and a lenticular lens are used for the image separation unit LES. In the example of FIG. 1, a lenticular lens including a plurality of band-shaped convex lenses LE is used as the image separation unit LES. The image separation unit LES is attached to the display panel DP. In the example of FIG. 1, a convex lens LE is disposed obliquely in the X direction (horizontal direction) and the Y direction (vertical direction) of the display panel DP, but the disposition of the convex lens LE is not limited thereto. The convex lens LE may be disposed parallel to the Y direction.

The image separation unit LES has a function of selecting a pixel PX visible from the viewer AU. For example, a plurality of viewpoints VP (refer to FIG. 7) from which a stereoscopic image can be observed are set in the real space. The plurality of pixels PX of the display panel DP are classified into a plurality of groups corresponding to different viewpoints VP. A viewpoint index ID indicating which viewpoint VP the pixel PX is classified into is assigned to each pixel PX. The image separation unit LES selectively supplies the image of the pixel PX to the viewpoint VP indicated by the viewpoint index.

In the example of FIG. 1, 24 viewpoints VP are set in the real space. Among the 24 viewpoints VP, 12 viewpoints (the 1st viewpoint VP-1 to the 12th viewpoint VP-12), which are half of the 24 viewpoints VP, are assigned to the left eye EP-L. The remaining 12 viewpoints (the 13th viewpoint VP-13 to the 24th viewpoint VP-24), which are half of the 24 viewpoints VP, are assigned to the right eye EP-R. Any one viewpoint VP among the 24 viewpoints VP is assigned to each pixel PX. A left eye image and a right eye image are generated by the viewpoint images of 12 viewpoints in which the position of the viewpoint VP is gradually changed. Stereoscopic vision is realized by selectively supplying the left eye image and the right eye image to the left eye EP-L and the right eye EP-R of the viewer AU, respectively.

The information processing apparatus 10 processes various types of information and integrally controls the overall display system 1. For example, the information processing apparatus 10 tracks the viewer AU based on sensor information acquired from the sensor unit 20. The information processing apparatus 10 sets a viewing area VA (refer to FIG. 7) based on the viewing position EP detected by tracking. The viewing area VA means a spatial region of the real space in which the 3D video can be stereoscopically observed. The information processing apparatus 10 assigns the viewpoint index ID to each pixel PX so that the 3D video of the central viewpoint VP is presented at the central portion of the viewing area VA. The information processing apparatus 10 assigns the viewpoint image of each viewpoint VP to each pixel PX based on the viewpoint index ID. As a result, a multiplexed image in which the plurality of viewpoint images are multiplexed is generated.

### 2. Functional Configuration of Display System

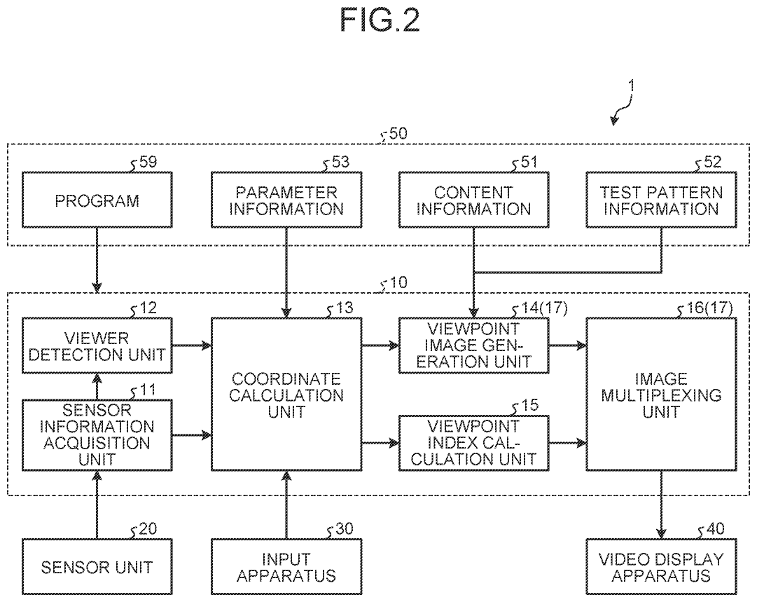

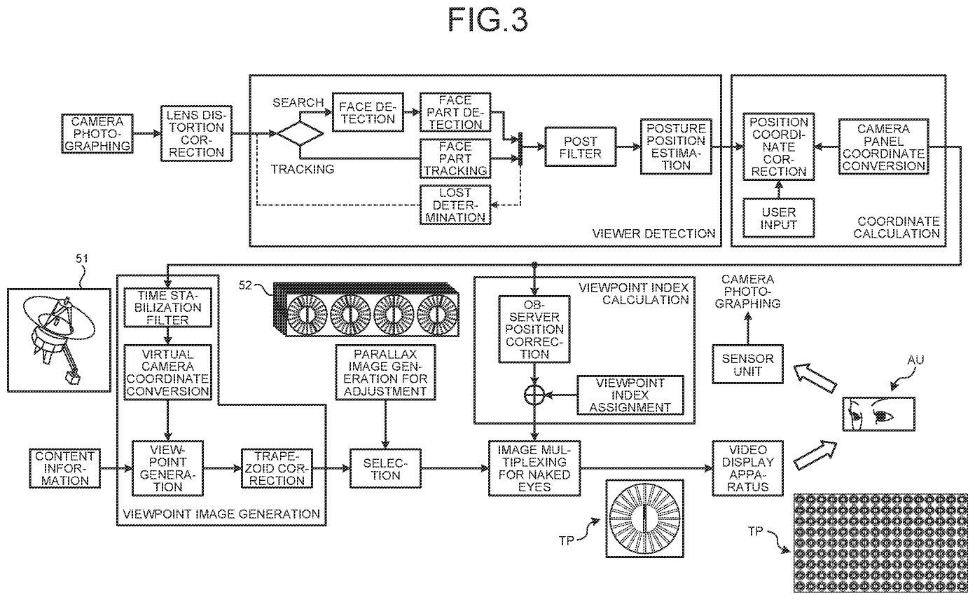

FIG. 2 is a diagram illustrating an example of a functional configuration of the display system 1. FIG. 3 is a diagram illustrating a flow of information processing in the display system 1.

The information processing apparatus 10 includes a sensor information acquisition unit 11, a viewer detection unit 12, a coordinate calculation unit 13, a viewpoint image generation unit 14, a viewpoint index calculation unit 15, and an image multiplexing unit 16.

### [2-1. Acquisition of Sensor Information]

The sensor information acquisition unit 11 acquires sensor information detected by the sensor unit 20. For example, the sensor information acquisition unit 11 sequentially acquires a visible light image CI (refer to FIG. 4) captured by the visible light camera at regular time intervals. The sensor information acquisition unit 11 performs preprocessing such as lens distortion correction on the visible light image CI and sequentially supplies the preprocessed image to the viewer detection unit 12 and the coordinate calculation unit 13.

### [2-2. Viewer Detection]

FIG. 4 is a diagram illustrating an example of a method of detecting the viewer AU.

The viewer detection unit 12 detects the viewer AU based on the sensor information. For example, the viewer detection unit 12 extracts a face part FP of the viewer AU from the visible light image CI sequentially acquired from the sensor information acquisition unit 11 using a known object recognition technique. The viewer detection unit 12 extracts, from the visible light image CI, coordinate information of the face part FP in a camera coordinate system.

The camera coordinate system is a coordinate system having an optical center CP of the visible light camera as an origin and an optical axis direction as a z direction. The visible light image CI is generated as an image obtained by projecting the face of the viewer AU on a plane (plane of z=f) separated from the optical center CP by a focal length f. The viewer detection unit 12 detects the position of the viewer AU in the camera coordinate system based on the coordinate information of the face part FP. The position of the viewer AU indicates, for example, the position of a contour or a feature point extracted from the face part FP. The viewer detection unit 12 supplies position information indicating the position of the viewer AU to the coordinate calculation unit 13.

For example, a detection state of the viewer AU includes a tracking state and a search state. The tracking state is a state in which detection is successful when the detection of the face part FP is tried last time. The search state is a state in which the face part FP is to be detected but cannot be detected.

When the face part FP is successfully detected, the detection state transitions to the tracking state. The viewer detection unit 12 tracks the face part FP in the tracking state. The tracking may be performed by extracting the face part FP for each visible light image CI, or may be performed using a known object tracking technique such as optical flow estimation. A post filter may be applied to the tracked face part FP for time stabilization.

When the face part FP is out of a tracking range, not found, or lost determination is made depending on the size of the face, the direction of the face, or the like, the detection state shifts to the search state. In the search state, the viewer detection unit 12 repeats the search until the face part FP is detected.

When the valid face part FP is extracted, the viewer detection unit 12 associates the face part FP with a face model SFM, and estimates a posture and a position of the face model SFM that matches the face part FP (posture position estimation). A 3D face part model of a standard human is used as the face model SFM. The viewer detection unit 12 calculates the position of the viewer AU in the camera coordinate system based on the estimated posture and position of the face model SFM. For the calculation of the posture position estimation, the coordinate information of all the face parts may be used, or only the coordinate information of some face parts may be used.

### [2-3. Calculation of Viewing Position]

The coordinate calculation unit 13 calculates the viewing position EP based on the position information of the viewer AU acquired from the viewer detection unit 12. The viewing position EP is calculated as three-dimensional coordinates of the eyes of the viewer AU in a panel coordinate system. The panel coordinate system is a world coordinate system of the real space in which the display panel DP is installed. For example, the coordinate calculation unit 13 performs coordinate conversion from the camera coordinate system to the panel coordinate system using a known perspective projection model. The coordinate calculation unit 13 calculates the position of the eye of the viewer AU in the panel coordinate system based on the coordinate conversion.

### [2-4. Generation of Viewpoint Image]

The viewpoint image generation unit 14 generates a plurality of viewpoint images corresponding to the respective viewpoints VP based on content information 51. The content information 51 includes information on a video content and an audio content provided by the video display apparatus 40.

For example, the viewpoint image generation unit 14 sets the viewpoint VP of a virtual camera at the position of the eyes of the viewer AU, and localizes a virtual object presented as a 3D video in the display space. The eye position of the viewer AU is calculated based on the coordinate information acquired from the coordinate calculation unit 13. In order to prevent the coordinate values from vibrating over the time, the viewpoint image generation unit 14 processes the coordinate information acquired from the coordinate calculation unit 13 with a digital filter (time stabilization filter) as necessary.

The viewpoint image generation unit 14 generates the viewpoint image in conjunction with the viewing position so that motion parallax is imparted according to the movement of the viewer AU. In a case where the viewpoint image is generated in conjunction with the viewing position, when there is an error in the viewing position, distortion occurs in the perspective, so that correction of the viewing area VA using a test pattern TP to be described later is effective. In a case where the motion parallax is not imparted, when the viewing position is fixed and displayed, and when the image data of the viewpoint image is included in the content information 51, the viewpoint VP can be fixed, or generation of the viewpoint image can be omitted.

The viewpoint image generation unit 14 can perform trapezoid correction on the viewpoint image as necessary. The trapezoid correction is for correcting perspective in a case where the viewer AU and the display panel DP do not face each other, for example, in a case where the display panel DP is inclined obliquely.

### [2-5. Calculation of Viewpoint Index]

The viewpoint index calculation unit 15 assigns a viewpoint index ID to each pixel PX of the display panel DP based on the viewing position EP acquired from the coordinate calculation unit 13. The viewpoint index ID is an index for identifying a viewpoint image. In the example of FIG. 1, 24 viewpoints VP are identified by numbers from 1 to 24. A number indicating the viewpoint VP is used as the viewpoint index ID. For example, the viewpoint index ID can be obtained by adding a dynamic correction value obtained from the viewing position EP to a static viewpoint index obtained only by parameters such as pitch, inclination, and offset of the convex lens LE.

### [2-6. Multiplexing of Viewpoint Images]

The image multiplexing unit 16 assigns the viewpoint image of the viewpoint VP corresponding to the viewpoint index ID to each pixel PX of the display panel DP. As a result, the image multiplexing unit 16 generates a multiplexed image in which a plurality of viewpoint images are multiplexed. For example, in a case where 24 viewpoints VP are set, a right eye image is assigned to the pixel PX having the viewpoint indexes from 1 to 12, and a left eye image is assigned to the pixel PX having the viewpoint indexes from 13 to 24. The multiplexed image is output to the display panel DP.

### 3. Test Pattern

As described above, the 3D face part model of the standard human is used as the face model SFM. This is because it is difficult to generate a face model for each viewer AU. When the face model SFM is substituted with the standard 3D face part model, an error occurs in the estimation result of the position and the posture of the face due to a difference in size between the actual face and the face model SFM. This error causes an error in the calculation result of the viewing position EP. The coordinates of the face part FP may also include an error, and this error also affects the calculation result of the viewing position EP.

When the error is included in the viewing position EP, the viewing area VA is not correctly set. When a positional relationship between the viewer AU and the viewing area VA deviates, crosstalk may be conspicuous and stereoscopic vision may be difficult. Therefore, in the present disclosure, the viewing position EP is corrected based on the measurement result using the test pattern TP.

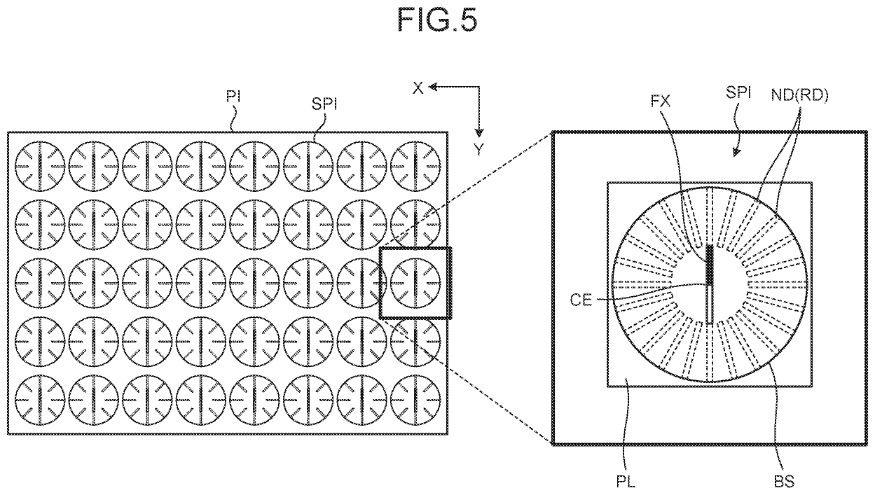

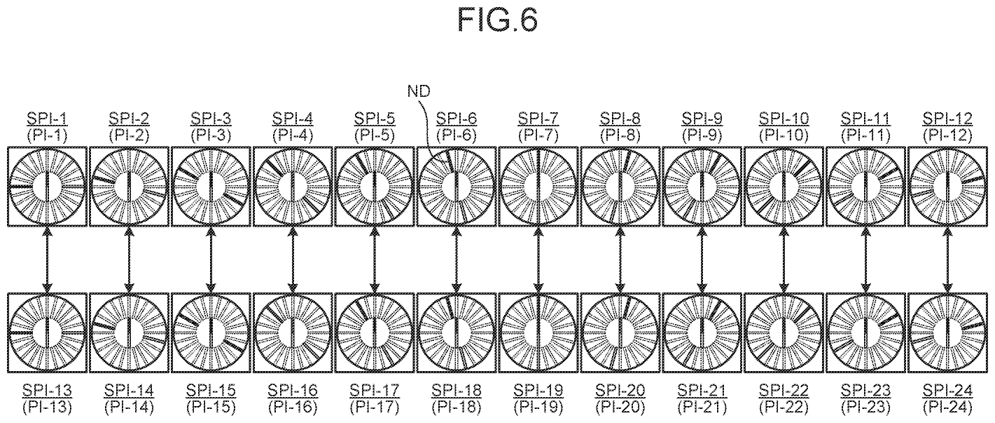

FIG. 5 is a diagram illustrating an example of the test pattern TP. FIG. 6 is a diagram illustrating an example of a plane image group forming the test pattern TP. The plane image group is a group of images expressing a change in the viewing position EP as a continuous morphological change of an image element.

The test pattern TP includes an image element indicating a positional relationship between the viewer AU and the viewing area VA. The appearance of the image element continuously changes according to the viewing position EP. In the example of FIG. 5, a rod-shaped portion RD is used as the image element indicating the positional relationship. The rod-shaped portion RD indicates a rotation direction according to the direction of deviation of the viewpoint VP from the center of the viewing area VA and a magnitude of the deviation.

For example, the test pattern TP is generated by multiplexing a plurality of plane images PI. Information on the plane image PI is defined in test pattern information 52. The plane image PI is generated and multiplexed by the viewpoint image generation unit 14 and the image multiplexing unit 16. The viewpoint image generation unit 14 and the image multiplexing unit 16 function as a test pattern generation unit 17 that generates the test pattern TP.

The viewpoint image generation unit 14 generates the plane image PI for each of the plurality of viewpoints VP set in the viewing area VA. The plane image PI indicates a relative position of the viewpoint VP with respect to the center of the viewing area VA. The image multiplexing unit 16 multiplexes the plurality of generated plane images PI to generate the test pattern TP. The plane image PI is generated, for example, as an image in which a plurality of sub-plane images SPI in which the rotation directions and the rotation amounts of the rod-shaped portions ND are equal are two-dimensionally arranged.

The sub-plane image SPI of the present disclosure is generated by imaging a magnetic azimuth needle. For example, the sub-plane image SPI includes a fixed needle FX, a rod-shaped portion ND, a circular base BS, and a plain portion PL. The fixed needle FX is a needle, the position and direction of which are fixed. The rod-shaped portion ND includes a rotating needle ND that rotates about the center of the base BS as a rotation center CE. The plain portion PL forms a background of the base BS.

The base BS and the plain portion PL form background portions of the fixed needle FX and the rod-shaped portion ND. The fixed needle FX and the rod-shaped portion ND have a higher visual attraction degree than that of the background portions serving as a background. The visual attraction degree indicates a degree of visual attraction. The visual attraction degree is adjusted by brightness, chroma, hue, transparency, and the like. For example, an image region having higher brightness and chroma has a higher visual attraction degree. A warm color has a higher visual attraction degree than that of a cool color. The lower the transparency, the higher the visual attraction degree. For example, the visual attraction degree increases in the order of the plain portion PL, the base BS, and the rotating needle ND. Since the fixed needle FX is generated as an image having the same brightness, chroma, hue, and transparency as those of the rotating needle ND, the fixed needle FX has the same visual attraction degree as that of the rotating needle ND.

For example, one end portion of the fixed needle FX is displayed in red, and the other end portion thereof is displayed in blue. The rotating needle ND includes a red portion and a blue portion facing each other with the rotation center CE interposed therebetween. When observed from the center of the viewing area VA, the color and direction of the rotating needle ND and the fixed needle FX match each other. The direction of the rotating needle ND to be observed varies depending on the viewing position EP. The movement of the rotating needle ND is similar to the movement of a magnet along a line of magnetic force. In the processing of adjusting the viewing area VA using the test pattern TP, the viewer AU adjusts a parameter value so that the colors and the directions of the rotating needle ND and the fixed needle FX match each other.

The viewpoint image generation unit 14 sets a distance between the viewpoints VP closest to an inter-pupillary distance as a reference distance. The viewpoint image generation unit 14 causes the viewpoint images of the two viewpoints VP separated by the reference distance to match each other. The inter-pupillary distance means a distance from the center of the iris of the right eye EP-R to the center of the iris of the left eye EP-L. The inter-pupillary distance of a typical adult male is 64 mm, and the inter-pupillary distance of an adult female is 62 mm. For example, the viewpoint image generation unit 14 calculates the standard inter-pupillary distance as 63 mm.

In the example of FIG. 6, the distance between the viewpoints VP separated by 12 viewpoints is the closest to the standard inter-pupillary distance. Therefore, viewpoint images of two viewpoints VP separated by 12 viewpoints are generated as the same image. In this way, an image without parallax is observed when the two viewpoint images are viewed with the left eye EP-L and the right eye EP-R. Therefore, there is no parallax inconsistency, and the visibility of the test pattern TP is enhanced.

For example, the rod-shaped portion RD of the plane images PI (the 1st plane image PI-1 to the 6th plane image PI-6, and the 13th plane image PI-13 to the 18th plane image PI-18) corresponding to the viewpoints VP (the 1st viewpoint VP-1 to the 6th viewpoint VP-6, and the 13th viewpoint VP-13 to the 18th viewpoint VP-18: refer to FIG. 7) that deviates from the center of the viewing area VA to the right side has a posture rotated in the counterclockwise direction with respect to the Y direction (vertical direction).

The rod-shaped portion RD of the plane images PI (the 8th plane image PI-8 to the 12th plane image PI-12, and the 20th plane image PI-20 to the 24th plane image PI-24) corresponding to the viewpoints VP (the 8th viewpoint VP-8 to the 12th viewpoint VP-12, and the 20th viewpoint VP-20 to the 24th viewpoint VP-24: refer to FIG. 7) that deviates from the center of the viewing area VA to the left side has a posture rotated in the clockwise direction with respect to the Y direction.

When the coordinates of the viewing position EP deviate from the center of the viewing area VA to the right side, the viewer AU can see the plane image PI in which the rod-shaped portion RD is inclined to the left side. When the coordinates of the viewing position EP deviate from the center of the viewing area VA to the left side, the viewer AU can see the plane image PI in which the rod-shaped portion RD is inclined to the right side. The observed magnitude (rotation amount) of the inclination of the rod-shaped portion RD increases as deviation from the center of the viewing area VA increases. The viewer AU can recognize in which direction and how much the viewing position EP deviates from the center of the viewing area VA based on the rotation direction and the rotation amount of the rod-shaped portion RD with respect to the fixed needle FX.

### 4. Relationship Between Viewing Position and Observation Pattern

[4-1. Example in which Viewing Position is Located at Center of Viewing Area]

FIG. 7 is a diagram illustrating an example in which the viewing position EP is located at the center of the viewing area VA.

The left eye EP-L of the viewer AU is disposed at the 19th viewpoint VP-19 at the central portion of a left eye viewing area VA-L. The right eye EP-R of the viewer AU is disposed at the 7th viewpoint VP-7 at the central portion of a right eye viewing area VA-L. In the upper portion of FIG. 7, an observation pattern OP of the left eye EP-L of the viewer AU is illustrated. The observation pattern OP is the plane image PI corresponding to the 19th viewpoint VP-19. Although not illustrated, the observation pattern of the right eye EP-R of the viewer AU is also the same as the observation pattern OP of the left eye EP-L. In the upper portion of FIG. 7, an observation pattern OP-L at a left end portion of the display panel DP, an observation pattern OP-C at the central portion thereof, and an observation pattern OP-R at a right end portion thereof are illustrated.

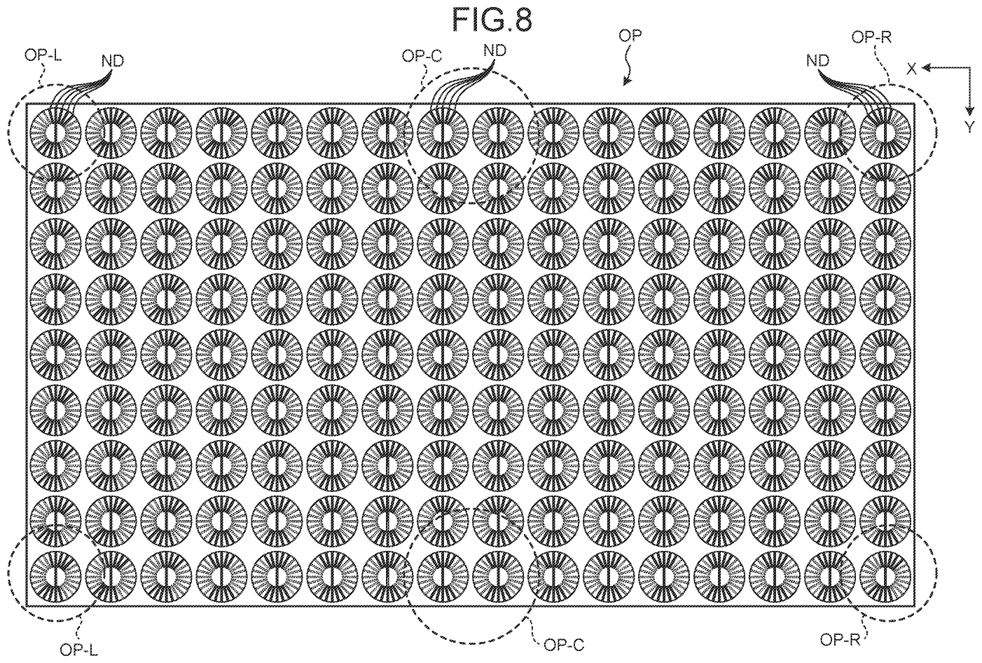

FIG. 8 is a diagram illustrating an actual observation pattern OP. FIG. 8 illustrates the observation pattern OP of the left eye EP-L, but the observation pattern of the right eye EP-R is the same.

If the viewpoints VP are not completely separated from each other, crosstalk may occur between the viewpoints VP. In this case, the plane images PI of the plurality of viewpoints VP having the 19th viewpoint VP-19 as a center thereof are observed in the left eye EP-L of the viewer AU. In the present disclosure, the image multiplexing unit 16 causes crosstalk between the adjacent viewpoints VP, thereby allowing each of the right eye EP-R and the left eye EP-L of the viewer AU to simultaneously observe the plane images PI of the two or more viewpoints VP at any position in the viewing area VA.

In the example of FIG. 8, the plane images PI of the 17th viewpoint VP-17, the 18th viewpoint VP-18, the 19th viewpoint VP-19, the 20th viewpoint VP-20, and the 21st viewpoint VP-21 are simultaneously observed in the left eye EP-L of the viewer AU. The plane images PI of the 5th viewpoint VP-5, the 6th viewpoint VP-6, the 7th viewpoint VP-7, the 8th viewpoint VP-8, and the 9th viewpoint VP-9 are simultaneously observed in the right eye EP-R of the viewer AU.

A plurality of rotating needles ND spreads in a fan shape at the end portion of the fixed needle FX. The center line of the fan indicates the average rotation direction of the rotating needle ND. The average rotation direction accurately suggests a deviation direction and a deviation amount of the viewing position EP from the center of the viewing area VA. In the example of FIG. 8, the average rotation direction coincides with the long axis direction of the fixed needle FX. The average rotation direction is substantially equal throughout the display panel DP. Therefore, it can be seen that the viewing position EP does not deviate from the center of the viewing area VA.

[4-2. Example in which Viewing Position Deviates from Center of Viewing Area to Right Side]

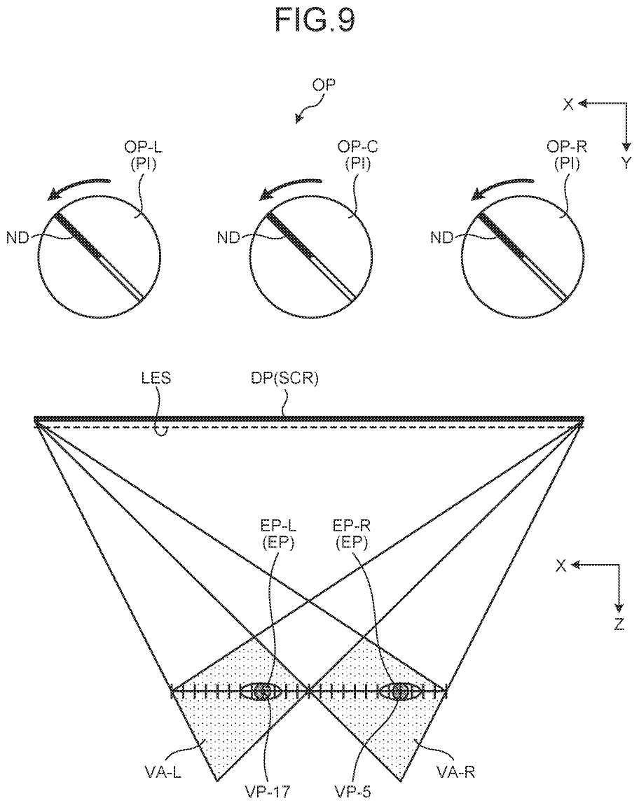

FIG. 9 is a diagram illustrating an example in which the viewing position EP deviates from the center of the viewing area VA to the right side.

The left eye EP-L of the viewer AU is disposed at the 17th viewpoint VP-17 that has deviated from the center of the left eye viewing area VA-L to the right side. The right eye EP-R of the viewer AU is disposed at the 5th viewpoint VP-5 that has deviated from the center of the right eye viewing area VA-L to the right side. The observation pattern OP of the left eye EP-L of the viewer AU is a plane image PI corresponding to the 17th viewpoint VP-17. Although not illustrated, the observation pattern of the right eye EP-R of the viewer AU is also the same as the observation pattern OP of the left eye EP-L.

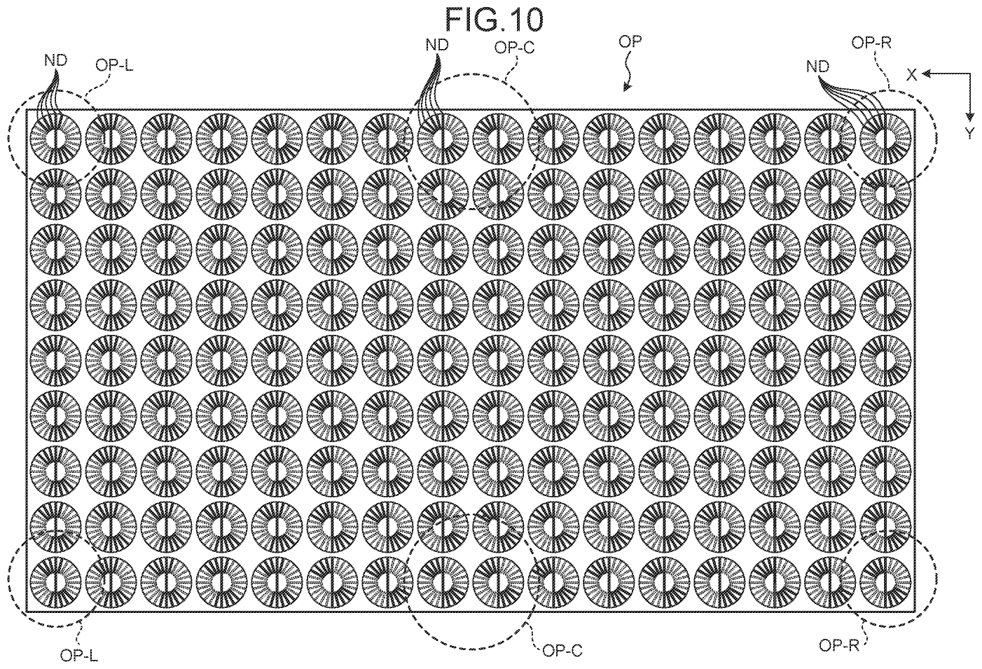

FIG. 10 is a diagram illustrating an actual observation pattern OP. FIG. 10 illustrates the observation pattern OP of the left eye EP-L, and the observation pattern of the right eye EP-R is also the same.

The plane images PI of a plurality of viewpoints VP having the 17th viewpoint VP-17 as a center thereof are observed in the left eye EP-L of the viewer AU. In the example of FIG. 10, the plane images PI of the 15th viewpoint VP-15, the 16th viewpoint VP-16, the 17th viewpoint VP-17, the 18th viewpoint VP-18, and the 19th viewpoint VP-19 are simultaneously observed in the left eye EP-L of the viewer AU. The plane images PI of the 3rd viewpoint VP-3, the 4th viewpoint VP-4, the 5th viewpoint VP-5, the 6th viewpoint VP-6, and the 7th viewpoint VP-7 are simultaneously observed in the right eye EP-R of the viewer AU.

The average rotation direction of the rotating needle ND is inclined to the left side from the long axis direction of the fixed needle FX. The average rotation direction is substantially equal throughout the display panel DP. Therefore, the viewer AU can recognize that the center of the viewing area VA exists on the left side, which is the inclination direction of the rotating needle ND, that is, the viewing position EP deviates from the center of the viewing area VA to the right side.

[4-3. Example in which Viewing Position Deviates from Center of Viewing Area to Left Side]

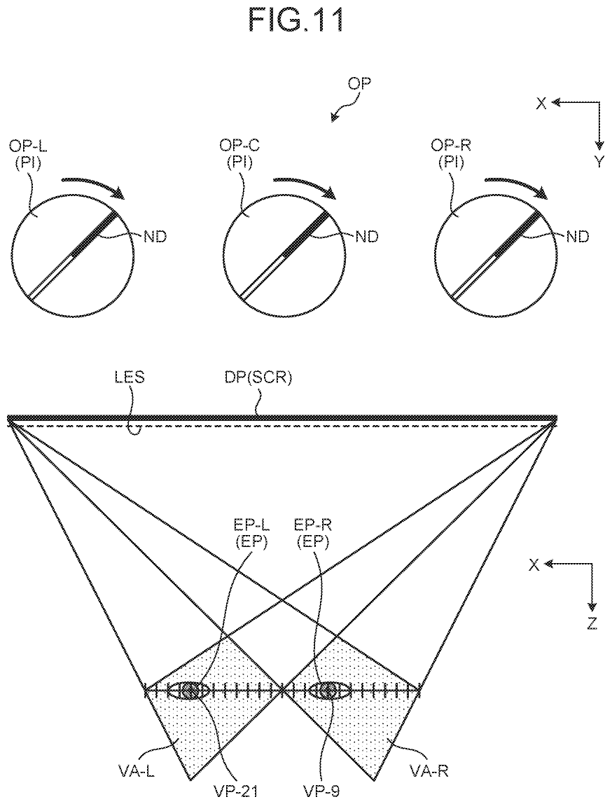

FIG. 11 is a diagram illustrating an example in which the viewing position EP deviates from the center of the viewing area VA to the left side.

The left eye EP-L of the viewer AU is disposed at the 21st viewpoint VP-21 that has deviated from the center of the left eye viewing area VA-L to the left side. The right eye EP-R of the viewer AU is disposed at the 9th viewpoint VP-9 that has deviated from the center of the right eye viewing area VA-L to the right side. The observation pattern OP of the left eye EP-L of the viewer AU is a plane image PI corresponding to the 21st viewpoint VP-21. Although not illustrated, the observation pattern of the right eye EP-R of the viewer AU is also the same as the observation pattern OP of the left eye EP-L.

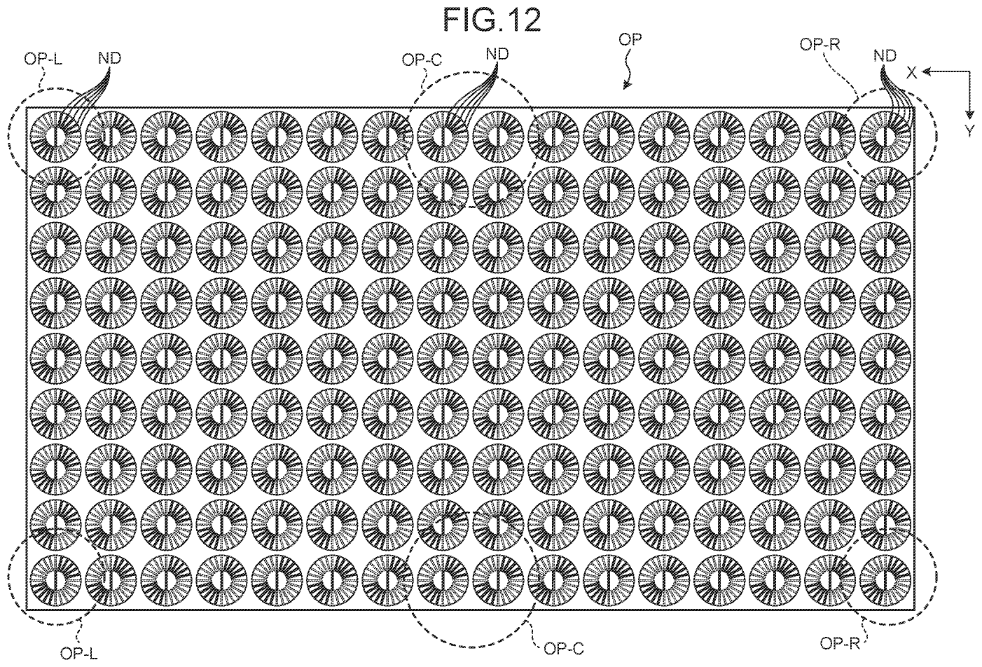

FIG. 12 is a diagram illustrating an actual observation pattern OP. FIG. 12 illustrates the observation pattern OP of the left eye EP-L, and the observation pattern of the right eye EP-R is also the same.

The plane images PI of a plurality of viewpoints VP having the 21st viewpoint VP-21 as a center thereof are observed in the left eye EP-L of the viewer AU. In the example of FIG. 12, the plane images PI of the 19th viewpoint VP-19, the 20th viewpoint VP-20, the 21st viewpoint VP-21, the 22nd viewpoint VP-22, and the 23rd viewpoint VP-23 are simultaneously observed in the left eye EP-L of the viewer AU. The plane images PI of the 7th viewpoint VP-7, the 8th viewpoint VP-8, the 9th viewpoint VP-9, the 10th viewpoint VP-10, and the 11th viewpoint VP-11 are simultaneously observed in the right eye EP-R of the viewer AU.

The average rotation direction of the rotating needle ND is inclined to the right side from the long axis direction of the fixed needle FX. The average rotation direction is substantially equal throughout the display panel DP. Therefore, the viewer AU can recognize that the center of the viewing area VA exists on the right side, which is the inclination direction of the rotating needle ND, that is, the viewing position EP deviates from the center of the viewing area VA to the left side.

[4-4. Example in which Viewing Position Deviates from Center of Viewing Area to Front Side]

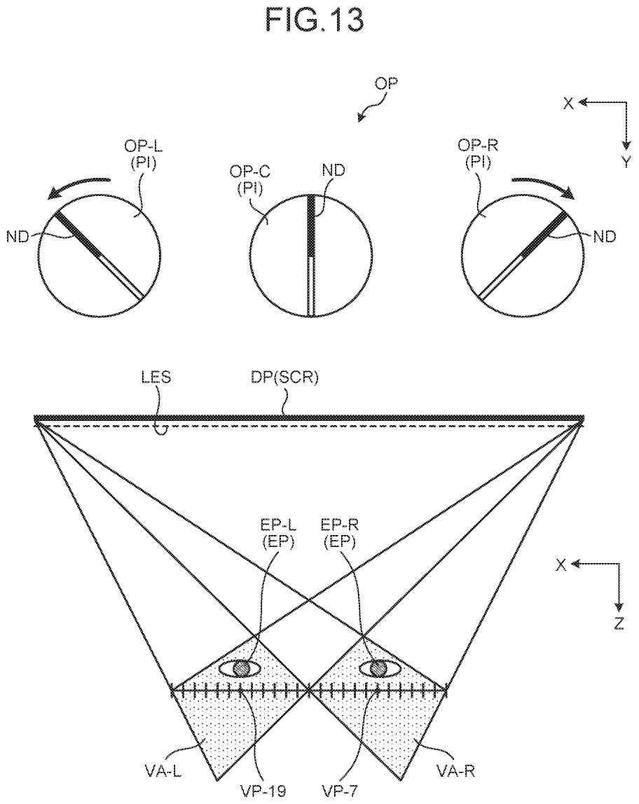

FIG. 13 is a diagram illustrating an example in which the viewing position EP deviates from the center of the viewing area VA to the front side (direction approaching the display panel DP).

The left eye EP-L of the viewer AU is disposed at a position that has deviated to the −z side from the 19th viewpoint VP-19 at the central portion of the left eye viewing area VA-L. The right eye EP-R of the viewer AU is disposed at a position that has deviated to the −z side from the 7th viewpoint VP-7 at the central portion of the right eye viewing area VA-L.

The observation pattern OP of the left eye EP-L of the viewer AU varies depending on the position of the display panel DP. The observation pattern OP-C at the central portion of the display panel DP is a plane image PI corresponding to the 19th viewpoint VP-19. The observation pattern OP-L at the left end portion is the plane image PI of the viewpoint VP on the right side of the 19th viewpoint VP-19. The observation pattern OP-R at the right end portion is the plane image PI of the viewpoint VP on the left side of the 19th viewpoint VP-19. Although not illustrated, the observation pattern of the right eye EP-R of the viewer AU is also the same as the observation pattern OP of the left eye EP-L.

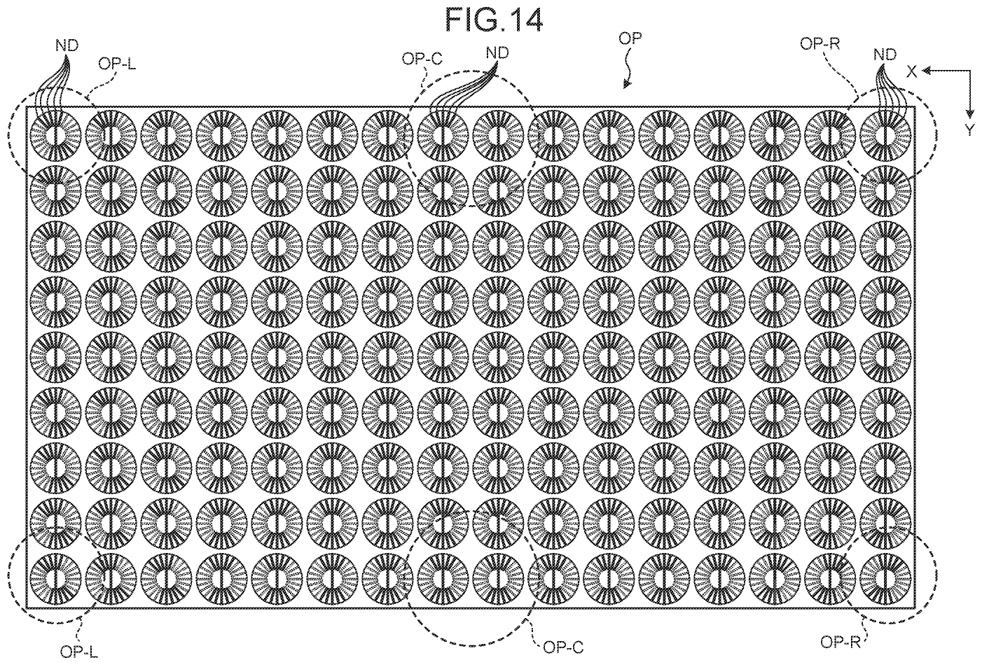

FIG. 14 is a diagram illustrating an actual observation pattern OP. FIG. 14 illustrates the observation pattern OP of the left eye EP-L, and the observation pattern of the right eye EP-R is also the same.

At the central portion of the display panel DP, the plane images PI of a plurality of viewpoints VP having the 19th viewpoint VP-19 as a center thereof are observed. In the example of FIG. 14, the plane images PI of the 17th viewpoint VP-17, the 18th viewpoint VP-18, the 19th viewpoint VP-19, the 20th viewpoint VP-20, and the 21st viewpoint VP-21 are simultaneously observed in the left eye EP-L of the viewer AU.

At the left end portion of the display panel DP, the plane images PI of a plurality of viewpoints VP having the 17th viewpoint VP-17 as a center thereof are observed. In the example of FIG. 14, the plane images PI of the 15th viewpoint VP-15, the 16th viewpoint VP-16, the 17th viewpoint VP-17, the 18th viewpoint VP-18, and the 19th viewpoint VP-19 are simultaneously observed in the left eye EP-L of the viewer AU.

At the right end portion of the display panel DP, the plane images PI of a plurality of viewpoints VP having the 21st viewpoint VP-21 as a center thereof are observed. In the example of FIG. 14, the plane images PI of the 19th viewpoint VP-19, the 20th viewpoint VP-20, the 21st viewpoint VP-21, the 22nd viewpoint VP-22, and the 23rd viewpoint VP-23 are simultaneously observed in the left eye EP-L of the viewer AU.

At the central portion of the display panel DP, the average rotation direction of the rotating needle ND coincides with the long axis direction of the fixed needle FX. At the left end portion of the display panel DP, the average rotation direction of the rotating needle ND is inclined to the left side from the long axis direction of the fixed needle FX. At the right end portion of the display panel DP, the average rotation direction of the rotating needle ND is inclined to the right side from the long axis direction of the fixed needle FX. Therefore, the viewer AU can recognize that the positional deviation in the horizontal direction (y direction) does not occur with respect to the center of the viewing area VA, and only the positional deviation in the forward-and-rearward direction (z direction) occurs.

[4-5. Example in which Viewing Position Deviates from Center of Viewing Area to Back Side]

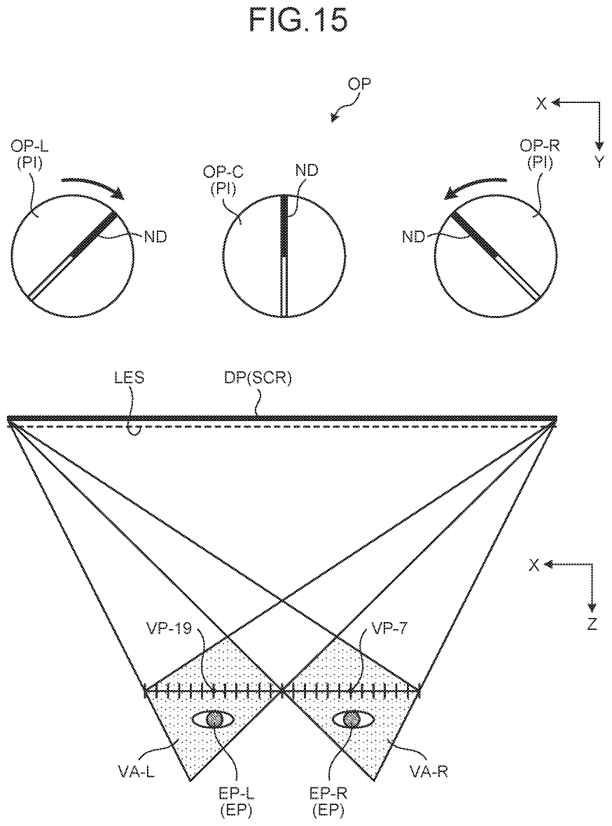

FIG. 15 is a diagram illustrating an example in which the viewing position EP deviates from the center of the viewing area VA to the back side (direction away from the display panel DP).

The left eye EP-L of the viewer AU is disposed at a position that has deviated to the +z side from the 19th viewpoint VP-19 at the central portion of the left eye viewing area VA-L. The right eye EP-R of the viewer AU is disposed at a position that has deviated to the +z side from the 7th viewpoint VP-7 at the central portion of the right eye viewing area VA-L.

The observation pattern OP of the left eye EP-L of the viewer AU varies depending on the position of the display panel DP. The observation pattern OP-C at the central portion of the display panel DP is a plane image PI corresponding to the 19th viewpoint VP-19. The observation pattern OP-L at the left end portion is the plane image PI of the viewpoint VP on the left side of the 19th viewpoint VP-19. The observation pattern OP-R at the right end portion is the plane image PI of the viewpoint VP on the right side of the 19th viewpoint VP-19. Although not illustrated, the observation pattern of the right eye EP-R of the viewer AU is also the same as the observation pattern OP of the left eye EP-L.

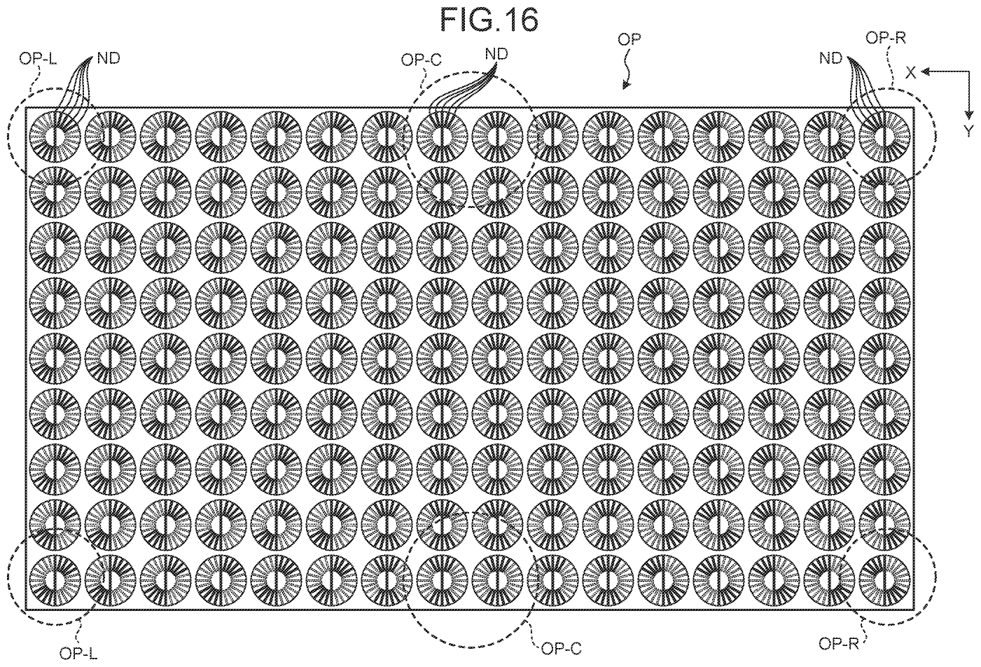

FIG. 16 is a diagram illustrating an actual observation pattern OP. FIG. 16 illustrates the observation pattern OP of the left eye EP-L, and the observation pattern of the right eye EP-R is also the same.

At the central portion of the display panel DP, the plane images PI of a plurality of viewpoints VP having the 19th viewpoint VP-19 as a center thereof are observed. In the example of FIG. 16, the plane images PI of the 17th viewpoint VP-17, the 18th viewpoint VP-18, the 19th viewpoint VP-19, the 20th viewpoint VP-20, and the 21st viewpoint VP-21 are simultaneously observed in the left eye EP-L of the viewer AU.

At the left end portion of the display panel DP, the plane images PI of a plurality of viewpoints VP having the 21st viewpoint VP-21 as a center thereof are observed. In the example of FIG. 16, the plane images PI of the 19th viewpoint VP-19, the 20th viewpoint VP-20, the 21st viewpoint VP-21, the 22nd viewpoint VP-22, and the 23rd viewpoint VP-23 are simultaneously observed in the left eye EP-L of the viewer AU.

At the right end portion of the display panel DP, the plane images PI of a plurality of viewpoints VP having the 17th viewpoint VP-17 as a center thereof are observed. In the example of FIG. 16, the plane images PI of the 15th viewpoint VP-15, the 16th viewpoint VP-16, the 17th viewpoint VP-17, the 18th viewpoint VP-18, and the 19th viewpoint VP-19 are simultaneously observed in the left eye EP-L of the viewer AU.

At the central portion of the display panel DP, the average rotation direction of the rotating needle ND coincides with the long axis direction of the fixed needle FX. At the left end portion of the display panel DP, the average rotation direction of the rotating needle ND is inclined to the right side from the long axis direction of the fixed needle FX. At the right end portion of the display panel DP, the average rotation direction of the rotating needle ND is inclined to the left side from the long axis direction of the fixed needle FX. Therefore, the viewer AU can recognize that the positional deviation in the horizontal direction (y direction) does not occur with respect to the center of the viewing area VA, and only the positional deviation in the forward-and-rearward direction (z direction) occurs.

### 5. Adjustment of Viewing Area

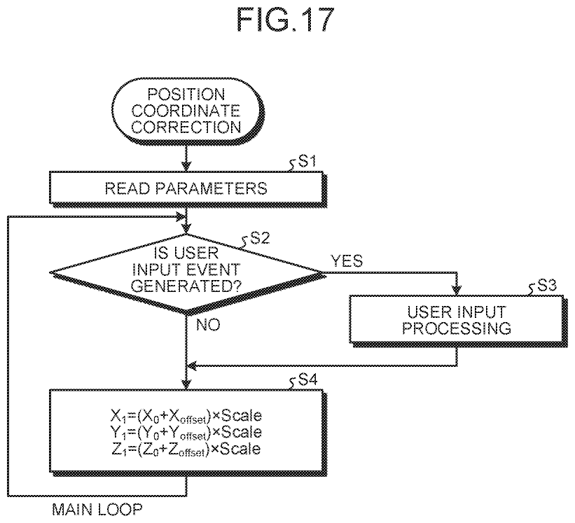

FIG. 17 is a diagram illustrating an example of a method of adjusting the viewing area VA.

The viewing area VA is calculated using the viewing position EP. When the error is included in the viewing position EP, the viewing area VA is not correctly set. Therefore, the coordinate calculation unit 13 corrects position information of the viewer AU acquired from the viewer detection unit 12 according to the following correction formulas.

$${X}_{1} = ( {X}_{0} + {X}_{offset} ) \times Scale \\ \\ \\ \\ {Y}_{1} = ( {Y}_{0} + {Y}_{offset} ) \times Scale \\ \\ \\ \\ {Z}_{1} = ( {Z}_{0} + {Z}_{offset} ) \times Scale$$

In the above-described correction formulas, (X₀, Y₀, Z₀) is the coordinates of the viewer AU in the camera coordinate system before correction. (X₁, Y₁, Z₁) is coordinates of the viewer AU in the camera coordinate system after the correction. (X_{offset}, Y_{offset}, Z_{offset}) is a parameter indicating an offset amount. Scale is a parameter indicating a scale value. Parameter values related to the offset amount and the scale value are defined in parameter information 53.

In step S1, the coordinate calculation unit 13 reads the parameter values related to the offset amount and the scale value from the parameter information 53. In step S2, the coordinate calculation unit 13 determines whether a user input event has occurred. The user input event means an input operation for the purpose of correction processing. For example, in a case where an operation of activating a program for correction processing is received from the viewer AU, it is determined that the user input event has occurred.

In a case where it is determined in step S2 that the user input event has not occurred (step S2: No), the processing proceeds to step S4. In step S4, the coordinate calculation unit 13 corrects the coordinates of the viewing position EP based on the parameter values read from the parameter information 53.

In a case where it is determined in step S2 that the user input event has occurred (step S2: Yes), the processing proceeds to step S3. In step S3, the coordinate calculation unit 13 receives user input processing to be described later. The coordinate calculation unit 13 adjusts the parameter values based on error information obtained by the user input processing. Then, in step S4, the coordinate calculation unit 13 corrects the coordinates of the viewer AU based on the adjusted parameter values.

Thereafter, the processing returns to step S2, and the above-described processing is repeated until an end operation is performed.

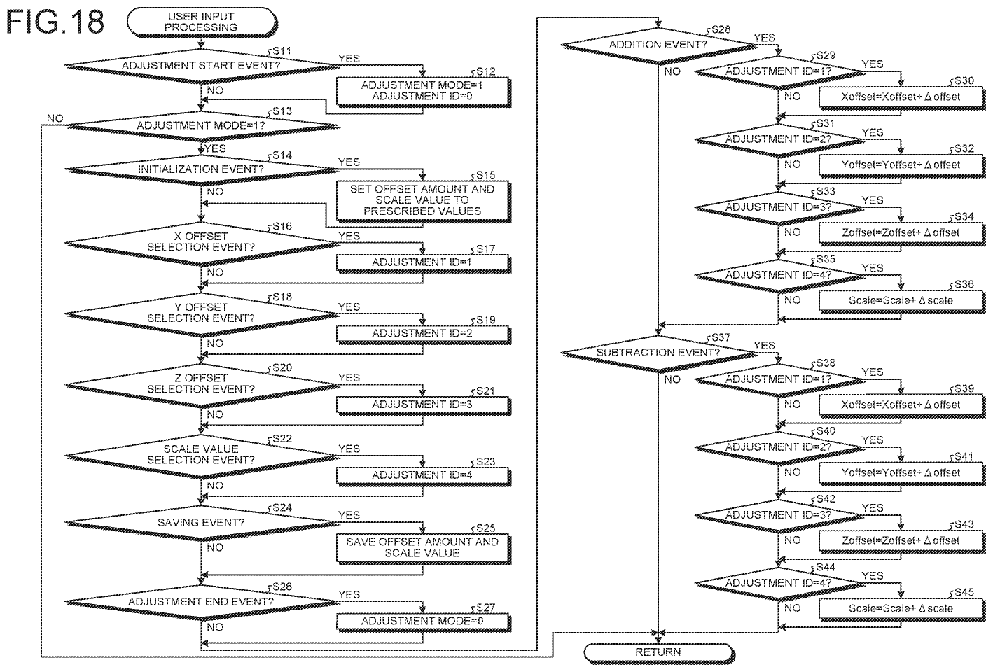

FIG. 18 is a diagram illustrating an example of the user input processing. Hereinafter, an example of an input operation using a keyboard will be described. At the start of the user input processing, an adjustment mode is set to 0.

In step S11, the coordinate calculation unit 13 determines whether an adjustment start event has occurred. The adjustment start event means an input operation for the purpose of adjustment processing of the viewing area VA. For example, in a case where an operation of an “F1” key on the keyboard is received from the viewer AU, it is determined that the adjustment start event has occurred.

In a case where it is determined in step S11 that the adjustment start event has occurred (step S11: Yes), the processing proceeds to step S12. In step S12, the coordinate calculation unit 13 sets the adjustment mode to 1 and an adjustment ID to 0. The image multiplexing unit 16 generates the test pattern TP and outputs the generated test pattern TP to the display panel DP. The assignment of the viewpoint index ID is performed based on the parameter values read from the parameter information 53. Then, the processing proceeds to step S13. In a case where it is determined in step S11 that no adjustment start event has occurred (step S11: No), the processing proceeds to step S13.

In step S13, the coordinate calculation unit 13 determines whether the adjustment mode is set to 1. In a case where it is determined in step S13 that the adjustment mode is not set to 1 (step S13: No), the processing returns to step S11, and the above-described processing is repeated until the adjustment start event occurs. In a case where it is determined in step S13 that the adjustment mode is set to 1 (step S13: Yes), the processing proceeds to step S14.

In step S14, the coordinate calculation unit 13 determines whether an initialization event has occurred. The initialization event means an input operation for the purpose of initializing the parameter values to a default specified value. For example, in a case where an operation of a “R” key on the keyboard is received from the viewer AU, it is determined that the initialization event has occurred.

In a case where it is determined in step S14 that the initialization event has occurred (step S14: Yes), the processing proceeds to step S15. In step S15, the coordinate calculation unit 13 sets the offset amount and the scale value to prescribed values. The image multiplexing unit 16 updates the test pattern TP based on the initialized offset amount and scale value, and outputs the updated test pattern TP to the display panel DP. In a case where it is determined in step S14 that no initialization event has occurred (step S14: No), the processing proceeds to step S16.

In step S16, the coordinate calculation unit 13 determines whether an X offset selection event has occurred. The X offset selection event means an input operation for the purpose of adjusting the viewing area VA in the x direction. For example, in a case where an operation of an “X” key on the keyboard is received from the viewer AU, it is determined that the X offset selection event has occurred.

In a case where it is determined in step S16 that the X offset selection event has occurred (step S16: Yes), the processing proceeds to step S17. In step S17, the coordinate calculation unit 13 sets the adjustment ID to 1, and the processing proceeds to step S18. In a case where it is determined in step S16 that the X offset selection event has not occurred (step S16: No), the processing proceeds to step S18.

In step S18, the coordinate calculation unit 13 determines whether a Y offset selection event has occurred. The Y offset selection event means an input operation for the purpose of adjusting the viewing area VA in the y direction. For example, when an operation of a “Y” key on the keyboard is received from the viewer AU, it is determined that the Y offset selection event has occurred.

In a case where it is determined in step S18 that the Y offset selection event has occurred (step S18: Yes), the processing proceeds to step S19. In step S19, the coordinate calculation unit 13 sets the adjustment ID to 2, and the processing proceeds to step S20. In a case where it is determined in step S18 that the Y offset selection event has not occurred (step S18: No), the processing proceeds to step S20.

In step S20, the coordinate calculation unit 13 determines whether a Z offset selection event has occurred. The Z offset selection event means an input operation for the purpose of adjusting the viewing area VA in the z direction. For example, in a case where an operation of a “Z” key on the keyboard is received from the viewer AU, it is determined that the Z offset selection event has occurred.

In a case where it is determined in step S20 that the Z offset selection event has occurred (step S20: Yes), the processing proceeds to step S21. In step S21, the coordinate calculation unit 13 sets the adjustment ID to 3, and the processing proceeds to step S22. In a case where it is determined in step S20 that the Z offset selection event has not occurred (step S20: No), the processing proceeds to step S22.

In step S22, the coordinate calculation unit 13 determines whether a scale value selection event has occurred. The scale value selection event means an input operation for the purpose of increasing or reducing the scale value. For example, in a case where an operation of a “C” key on the keyboard is received from the viewer AU, it is determined that the scale value selection event has occurred.

In a case where it is determined in step S22 that the scale value selection event has occurred (step S22: Yes), the processing proceeds to step S23. In step S23, the coordinate calculation unit 13 sets the adjustment ID to 4, and the processing proceeds to step S24. In a case where it is determined in step S22 that no scale value selection event has occurred (step S22: No), the processing proceeds to step S24.

In step S24, the coordinate calculation unit 13 determines whether a saving event has occurred. The saving event means an input operation for the purpose of saving the offset amount and the scale value. For example, in a case where an operation of an “S” key on the keyboard is received from the viewer AU, it is determined that the saving event has occurred.

In a case where it is determined in step S24 that the saving event has occurred (step S24: Yes), the processing proceeds to step S25. In step S25, the coordinate calculation unit 13 saves the offset amount and the scale value, updates the parameter information 53, and the processing proceeds to step S26. In a case where it is determined in step S24 that no saving event has occurred (step S24: No), the processing proceeds to step S26.

In step S26, the coordinate calculation unit 13 determines whether an adjustment end event has occurred. The adjustment end event means an input operation for the purpose of ending the adjustment processing. For example, in a case where an operation of a “Q” key on the keyboard is received from the viewer AU, it is determined that the adjustment end event has occurred.

In a case where it is determined in step S26 that the adjustment end event has occurred (step S26: Yes), the processing proceeds to step S27. In step S27, the coordinate calculation unit 13 sets the adjustment mode to 0, and the processing proceeds to step S28. In a case where it is determined in step S26 that no adjustment end event has occurred (step S26: No), the processing proceeds to step S28.

In step S28, the coordinate calculation unit 13 determines whether an addition event has occurred. The addition event means an input operation for the purpose of defining adjustment of a parameter value as addition processing. For example, in a case where an operation of a “→” (rightward arrow) key of the keyboard is received from the viewer AU, it is determined that the addition event has occurred.

In a case where it is determined in step S28 that no addition event has occurred (step S28: No), the processing proceeds to step S37. In a case where it is determined in step S28 that the addition event has occurred (step S28: Yes), the processing proceeds to step S29.

In step S29, the coordinate calculation unit 13 determines whether the adjustment ID is 1. In a case where it is determined in step S29 that the adjustment ID is 1 (step S29: Yes), the processing proceeds to step S30. In step S30, the coordinate calculation unit 13 adds Δ_{offset} to X_{offset}. Δ_{offset} means a unit adjustment amount. The image multiplexing unit 16 updates the test pattern TP based on the updated offset amount and outputs the updated test pattern TP to the display panel DP. Then, the processing proceeds to step S31. In a case where it is determined in step S29 that the adjustment ID is not 1 (step S29: No), the processing proceeds to step S31.

In step S31, the coordinate calculation unit 13 determines whether the adjustment ID is 2. In a case where it is determined in step S31 that the adjustment ID is 2 (step S31: Yes), the processing proceeds to step S32. In step S32, the coordinate calculation unit 13 adds Δ_{offset} to Y_{offset}. The image multiplexing unit 16 updates the test pattern TP based on the updated offset amount and outputs the updated test pattern TP to the display panel DP. Then, the processing proceeds to step S33. In a case where it is determined in step S31 that the adjustment ID is not 2 (step S31: No), the processing proceeds to step S33.

In step S33, the coordinate calculation unit 13 determines whether the adjustment ID is 3. In a case where it is determined in step S33 that the adjustment ID is 3 (step S33: Yes), the processing proceeds to step S34. In step S34, the coordinate calculation unit 13 adds Δ_{offset} to Z_{offset}. The image multiplexing unit 16 updates the test pattern TP based on the updated offset amount and outputs the updated test pattern TP to the display panel DP. Then, the processing proceeds to step S35. In a case where it is determined in step S33 that the adjustment ID is not 3 (step S33: No), the processing proceeds to step S35.

In step S35, the coordinate calculation unit 13 determines whether the adjustment ID is 4. In a case where it is determined in step S35 that the adjustment ID is 4 (step S35: Yes), the processing proceeds to step S36. In step S36, the coordinate calculation unit 13 adds Δ_{scale} to Scale. The image multiplexing unit 16 updates the test pattern TP based on the updated scale value, and outputs the updated test pattern TP to the display panel DP. Then, the processing proceeds to step S37. In a case where it is determined in step S35 that the adjustment ID is not 4 (step S35: No), the processing proceeds to step S37.

In step S37, the coordinate calculation unit 13 determines whether a subtraction event has occurred. The subtraction event means an input operation for the purpose of defining adjustment of a parameter value as subtraction processing. For example, in a case where an operation of a “←” (leftward arrow) key on the keyboard is received from the viewer AU, it is determined that the subtraction event has occurred.

In a case where it is determined in step S37 that the subtraction event has occurred (step S37: Yes), the processing proceeds to step S38. In step S38, the coordinate calculation unit 13 determines whether the adjustment ID is 1. In a case where it is determined in step S38 that the adjustment ID is 1 (step S38: Yes), the processing proceeds to step S39. In step S39, the coordinate calculation unit 13 subtracts Δ_{offset} from X_{offset}. The image multiplexing unit 16 updates the test pattern TP based on the updated offset amount and outputs the updated test pattern TP to the display panel DP. Then, the processing proceeds to step S40. In a case where it is determined in step S38 that the adjustment ID is not 1 (step S38: No), the processing proceeds to step S40.

In step S40, the coordinate calculation unit 13 determines whether the adjustment ID is 2. In a case where it is determined in step S40 that the adjustment ID is 2 (step S40: Yes), the processing proceeds to step S41. In step S41, the coordinate calculation unit 13 subtracts Δ_{offset} from Y_{offset}. The image multiplexing unit 16 updates the test pattern TP based on the updated offset amount and outputs the updated test pattern TP to the display panel DP. Then, the processing proceeds to step S42. In a case where it is determined in step S40 that the adjustment ID is not 2 (step S40: No), the processing proceeds to step S42.

In step S42, the coordinate calculation unit 13 determines whether the adjustment ID is 3. In a case where it is determined in step S42 that the adjustment ID is 3 (step S42: Yes), the processing proceeds to step S43. In step S43, the coordinate calculation unit 13 subtracts Δ_{offset} from Z_{offset}. The image multiplexing unit 16 updates the test pattern TP based on the updated offset amount and outputs the updated test pattern TP to the display panel DP. Then, the processing proceeds to step S44. In a case where it is determined in step S42 that the adjustment ID is not 3 (step S42: No), the processing proceeds to step S44.

In step S44, the coordinate calculation unit 13 determines whether the adjustment ID is 4. In a case where it is determined in step S44 that the adjustment ID is 4 (step S44: Yes), the processing proceeds to step S45. In step S45, the coordinate calculation unit 13 subtracts Δ_{scale} from Scale. The image multiplexing unit 16 updates the test pattern TP based on the updated offset amount and outputs the updated test pattern TP to the display panel DP. Then, the processing returns to step S11. In a case where it is determined in step S44 that the adjustment ID is not 4 (step S44: No), the processing returns to step S11. Then, the above-described processing is repeated until an end operation is performed.

By the above-described processing, the parameter value of each parameter (X_{offset}, Y_{offset}, Z_{offset}, Scale) is corrected by the unit correction amount. The coordinate calculation unit 13 detects the correction amount for each parameter acquired during the processing period of the user input processing as error information of the viewing position EP. The coordinate calculation unit 13 calculates the coordinates of the viewing position EP using the error information of the viewing position EP acquired based on the observation result of the test pattern TP.

For example, the coordinate calculation unit 13 applies the offset amount and the scale value corrected based on the error information to the above-described formulas, and calculates coordinates (X₁, Y₁, Z₁) of the viewer AU in the camera coordinate system. The coordinate calculation unit 13 converts the coordinates (X₁, Y₁, Z₁) into coordinates of the panel coordinate system, and calculates the coordinates of the viewing position EP based on the converted coordinates. As a result, the coordinates of the viewing position EP corrected based on the error information are obtained. The viewpoint index calculation unit 15 assigns a viewpoint index ID based on the corrected coordinates of the viewing position EP.

Referring back to FIG. 2, the storage apparatus 50 stores the content information 51, the test pattern information 52, the parameter information 53, and a program 59. The program 59 is a program that causes a computer to execute information processing according to the present embodiment. The information processing apparatus 10 performs various types of processing in accordance with the program 59 stored in the storage apparatus 50. The storage apparatus 50 may be used as a work area for temporarily storing a processing result of the information processing apparatus 10. The storage apparatus 50 includes any non-transitory storage medium, such as a semiconductor storage medium and a magnetic storage medium. The storage apparatus 50 includes, for example, an optical disk, a magneto-optical disk, or a flash memory. The program 59 is stored in, for example, a non-transitory computer-readable storage medium.

The information processing apparatus 10 is, for example, a computer including a processor and a memory. The memory of the information processing apparatus 10 includes a random access memory (RAM) and a read only memory (ROM). The information processing apparatus 10 functions as the sensor information acquisition unit 11, the viewer detection unit 12, the coordinate calculation unit 13, the viewpoint image generation unit 14, the viewpoint index calculation unit 15, and the image multiplexing unit 16 by executing the program 59.

### 6. Effects

The information processing apparatus 10 includes the test pattern generation unit 17. The test pattern generation unit 17 generates the test pattern TP in which the appearance of an image element indicating a positional relationship between the viewer AU and the viewing area VA continuously changes depending on the viewing position EP. In the information processing method of the present disclosure, processing of the information processing apparatus 10 is executed by a computer. The program 59 of the present disclosure causes a computer to implement the processing of the information processing apparatus 10.

According to this configuration, the test pattern TP continuously changes depending on the viewing position EP. Therefore, it is possible to recognize in detail at which position in the viewing area VA the viewer AU is located.

The test pattern generation unit 17 generates the plane image PI for each of the plurality of viewpoints VP set in the viewing area VA. The plane image PI is an image indicating the relative position of the viewpoint VP with respect to the center of the viewing area VA. The test pattern generation unit 17 multiplexes the plurality of generated plane images PI to generate the test pattern TP.

According to this configuration, it is possible to easily recognize at which position the viewer AU is located with respect to the center of the viewing area VA.

The test pattern generation unit 17 causes each of the right eye EP-R and the left eye EP-L of the viewer AU to simultaneously observe the plane images PI of two or more viewpoints VP.

According to this configuration, the test pattern TP smoothly changes depending on the viewing position EP.

The plane image PI includes, as an image element indicating a positional relationship between the viewer AU and the viewing area VA, the rod-shaped portion RD indicating a rotation direction in accordance with a deviation direction and a deviation magnitude of the viewpoint VP from the center of the viewing area VA.

According to this configuration, how much and in which direction the viewing position EP deviates from the center of the viewing area VA is quantitatively grasped based on the rotation direction of the rod-shaped portion RD.

The test pattern generation unit 17 sets a distance between the viewpoints VP closest to an inter-pupillary distance as a reference distance. The test pattern generation unit 17 causes the viewpoint images of the two viewpoints VP separated by the reference distance to match each other.

According to this configuration, an image without parallax is observed when two viewpoint images are viewed with the left eye EP-L and the right eye EP-R. Therefore, there is no parallax inconsistency, and the visibility of the test pattern TP is enhanced.

The plane image PI is an image in which a plurality of sub-plane images SPI in which the rotation direction and the rotation amount of the rod-shaped portion RD are equal are two-dimensionally arranged.

According to this configuration, a two-dimensional distribution of the rotation direction of the rod-shaped portion RD is observed. Distributions of different rotation directions are observed in a case where the viewing position EP moves in the forward-and-rearward direction with respect to the center of the viewing area VA and in a case where the viewing position EP moves in the left-and-right direction with respect to the center of the viewing area VA. Therefore, by observing the distribution of the rotation direction, it is recognized whether the viewing position EP deviates in the forward-and-rearward direction or the left-and-right direction with respect to the center of the viewing area VA.

The rod-shaped portion RD has a higher visual attraction degree than that of a background portion serving as a background of the rod-shaped portion RD.

According to this configuration, the rotation direction of the rod-shaped portion RD is easily recognized.

The background portion includes a circular base BS and the plain portion PL forming the background of the base BS. The rod-shaped portion RD includes the rotating needle ND that rotates about the center of the base BS as the rotation center CE. The visual attraction degree increases in the order of the plain portion PL, the base BS, and the rotating needle ND.

According to this configuration, the rotation direction of the rod-shaped portion RD is easily recognized.

The rod-shaped portion RD of the plane image PI corresponding to the viewpoint VP deviating from the center of the viewing area VA to the right side has a posture rotated in a counterclockwise direction with respect to the vertical direction. The rod-shaped portion RD of the plane image PI corresponding to the viewpoint VP deviating from the center of the viewing area VA to the left side has a posture rotated in a clockwise direction with respect to the vertical direction.

According to this configuration, the rod-shaped portion RD rotates toward a direction in which the center of the viewing area VA is located. Therefore, it is easy to sensuously understand whether the center of the viewing area VA is on the right side or the left side with respect to the current viewing position EP.

The coordinate calculation unit 13 calculates the coordinates of the viewing position EP using the error information of the viewing position EP acquired based on the observation result of the test pattern TP. The viewpoint index calculation unit 15 assigns a viewpoint index ID based on the corrected coordinates.

According to this configuration, the viewing area VA is appropriately adjusted in accordance with the viewing position EP while maintaining the viewing position EP.

It is noted that the effects described in the present specification are merely examples and are not limited, and other effects may be obtained.

### 7. First Modification

In the above embodiment, the viewing area VA is adjusted based on the observation result of the test pattern TP. However, the viewer AU may search for the center of the viewing area VA based on the observation result of the test pattern TP, and may move to the center thereof to perform viewing.

### 8. Second Modification

In the above embodiment, the parameter value corrected by the user input processing is stored in the parameter information 53. The corrected parameter value can be used as it is for the next viewing as a parameter value optimized for the viewer AU. In a case where the display system 1 is shared by a plurality of viewers AU, the corrected parameter value can be defined in the parameter information 53 in association with the viewer AU.

### 9. Third Modification

In the above-described user input processing, an appropriate parameter value is searched while repeating the change of the parameter value and the update of the test pattern TP. In this method, a parameter value to be corrected is searched through trial and error. However, it is also conceivable to provide a guideline as to which parameter value should be corrected in order to shorten the search time. For example, the coordinate calculation unit 13 intentionally causes each parameter value to deviate, thereby allowing the viewer AU to recognize relevance between a change in the parameter value and a change in the observation pattern OP. As a result, the viewer AU can easily narrow down the parameter value to be corrected.

### 10. Fourth Modification

In the above embodiment, in order to observe the two-dimensional distribution of the rotation direction of the rod-shaped portion RD, the plane image PI includes a plurality of sub-plane images SPI having the same rotation direction of the rod-shaped portion RD. In the example of FIG. 8, 16 sub-plane images SPI are two-dimensionally arranged so as to be arranged in the x direction and 9 sub-plane images SPI are two-dimensionally arranged so as to be arranged in the y direction, but the number of sub-plane images SPI and the arrangement thereof are not limited thereto. For example, when each sub-plane image SPI is too small, the size per sub-plane image SPI can be increased to reduce the number thereof. The overall number can also be reduced without changing the size of each sub-plane image SPI. In addition, the arrangement of the sub-plane images SPI can be made into a cross shape, or the sub-plane images SPI adjusted to an appropriate size can be arranged only at nine places of the center, the top and bottom, the left and right, and the four corners of the display panel DP.

### Supplementary Note

It is noted that the present technique can also have the following configurations.

(1)

An information processing apparatus comprising a test pattern generation unit configured to generate a test pattern in which appearance of an image element continuously changes depending on a viewing position, the image element indicating a positional relationship between a viewer and a viewing area.

(2)

The information processing apparatus according to (1), wherein
the test pattern generation unit generates a plane image indicating a relative position of a viewpoint with respect to a center of the viewing area for each of a plurality of the viewpoints set in the viewing area, and generates the test pattern by multiplexing the plurality of generated plane images.
   (3)

The information processing apparatus according to (2), wherein
the test pattern generation unit causes each of a right eye and a left eye of the viewer to simultaneously observe the plane images of two or more viewpoints.
   (4)

The information processing apparatus according to (2) or (3), wherein
the test pattern generation unit sets a distance between the viewpoints closest to an inter-pupillary distance as a reference distance, and causes viewpoint images of the two viewpoints separated by the reference distance to match each other.
   (5)

The information processing apparatus according to any one of (2) to (4), wherein
the plane image includes, as the image element, a rod-shaped portion indicating a rotational posture in accordance with a direction of deviation of the viewpoint from the center of the viewing area and a magnitude of the deviation thereof.
   (6)

The information processing apparatus according to (5), wherein
the plane image is an image obtained by two-dimensionally arranging a plurality of sub-plane images, the sub-plane images having the same rotation direction and rotation amount of the rod-shaped portion.
   (7)

The information processing apparatus according to (5) or (6), wherein
the rod-shaped portion has a visual attraction degree higher than a visual attraction degree of a background portion serving as a background of the rod-shaped portion.
   (8)

The information processing apparatus according to (7), wherein
the background portion includes a circular base and a plain portion forming a background of the base,
the rod-shaped portion includes a rotating needle rotating about a center of the base as a rotation center, and
the visual attraction degree becomes higher in the order of the plain portion, the base, and the rotating needle.
   (9)

The information processing apparatus according to any one of (5) to (8), wherein
the rod-shaped portion of the plane image corresponding to the viewpoint that has deviated from the center of the viewing area to a right side has a posture rotated in a counterclockwise direction with respect to a vertical direction, and
the rod-shaped portion of the plane image corresponding to the viewpoint that has deviated from the center of the viewing area to a left side has a posture rotated in a clockwise direction with respect to the vertical direction.
   (10)

The information processing apparatus according to any one of (1) to (9), further comprising:
a coordinate calculation unit configured to calculate coordinates of the viewing position using error information of the viewing position acquired based on an observation result of the test pattern; and
a viewpoint index calculation unit configured to perform assignment of a viewpoint index based on the corrected coordinates.
   (11)

An information processing method executed by a computer, the method comprising generating a test pattern in which appearance of an image element continuously changes depending on a viewing position, the image element indicating a positional relationship between a viewer and a viewing area.

(12)

A program for causing a computer to execute generating a test pattern in which appearance of an image element continuously changes depending on a viewing position, the image element indicating a positional relationship between a viewer and a viewing area.

### REFERENCE SIGNS LIST

10 INFORMATION PROCESSING APPARATUS
13 COORDINATE CALCULATION UNIT
15 VIEWPOINT INDEX CALCULATION UNIT
17 TEST PATTERN GENERATION UNIT
AU VIEWER
BS BASE
EP VIEWING POSITION
ID VIEWPOINT INDEX
ND ROTATING NEEDLE
PI PLANE IMAGE
PL PLAIN PORTION
RD ROD-SHAPED PORTION
SPI SUB-PLANE IMAGE
TP TEST PATTERN
VA VIEWING AREA
VP VIEWPOINT

1. An information processing apparatus comprising a test pattern generation unit configured to generate a test pattern in which appearance of an image element continuously changes depending on a viewing position, the image element indicating a positional relationship between a viewer and a viewing area.

2. The information processing apparatus according to claim 1, wherein
the test pattern generation unit generates a plane image indicating a relative position of a viewpoint with respect to a center of the viewing area for each of a plurality of the viewpoints set in the viewing area, and generates the test pattern by multiplexing the plurality of generated plane images.

3. The information processing apparatus according to claim 2, wherein
the test pattern generation unit causes each of a right eye and a left eye of the viewer to simultaneously observe the plane images of two or more viewpoints.

4. The information processing apparatus according to claim 2, wherein
the test pattern generation unit sets a distance between the viewpoints closest to an inter-pupillary distance as a reference distance, and causes viewpoint images of the two viewpoints separated by the reference distance to match each other.

5. The information processing apparatus according to claim 2, wherein
the plane image includes, as the image element, a rod-shaped portion indicating a rotational posture in accordance with a direction of deviation of the viewpoint from the center of the viewing area and a magnitude of the deviation thereof.

6. The information processing apparatus according to claim 5, wherein
the plane image is an image obtained by two-dimensionally arranging a plurality of sub-plane images, the sub-plane images having the same rotation direction and rotation amount of the rod-shaped portion.

7. The information processing apparatus according to claim 5, wherein
the rod-shaped portion has a visual attraction degree higher than a visual attraction degree of a background portion serving as a background of the rod-shaped portion.

8. The information processing apparatus according to claim 7, wherein
the background portion includes a circular base and a plain portion forming a background of the base,
the rod-shaped portion includes a rotating needle rotating about a center of the base as a rotation center, and
the visual attraction degree becomes higher in the order of the plain portion, the base, and the rotating needle.

9. The information processing apparatus according to claim 5, wherein
the rod-shaped portion of the plane image corresponding to the viewpoint that has deviated from the center of the viewing area to a right side has a posture rotated in a counterclockwise direction with respect to a vertical direction, and
the rod-shaped portion of the plane image corresponding to the viewpoint that has deviated from the center of the viewing area to a left side has a posture rotated in a clockwise direction with respect to the vertical direction.

10. The information processing apparatus according to claim 1, further comprising:
a coordinate calculation unit configured to calculate coordinates of the viewing position using error information of the viewing position acquired based on an observation result of the test pattern; and
a viewpoint index calculation unit configured to perform assignment of a viewpoint index based on the corrected coordinates.

11. An information processing method executed by a computer, the method comprising generating a test pattern in which appearance of an image element continuously changes depending on a viewing position, the image element indicating a positional relationship between a viewer and a viewing area.

12. A program for causing a computer to execute generating a test pattern in which appearance of an image element continuously changes depending on a viewing position, the image element indicating a positional relationship between a viewer and a viewing area.
